(19) United States
(12) Patent Application Publication
(10) Pub. No.: US 2005/0086070 A1
(43) Pub. Date: Apr. 21, 2005

(54) Wireless automobile valuation information service

(76) Inventor: Paul R. Engelman, Fort Myers, FL (US)

Correspondence Address: ANTHONY R BARKUME, 20 GATEWAY LANE, MANORVILLE, NY, 11949, US

(21) Appl. No.: 10/966,799

(22) Filed: Oct. 15, 2004

Related U.S. Application Data
(60) Provisional application No. 60/511,632, filed on Oct. 15, 2003.

(51) Int. Cl. G06F 17/60

(52) U.S. Cl. 705/1; 705/8

(57) ABSTRACT

A system and methodology for providing timely information regarding an automobile or other vehicle from one or more sources linked by a global computer network such as the Internet to a device such as a hand-held portable wireless device (cellular or LAN), whereby the vehicle information may be displayed to a user and utilized by the user for making a purchase decision regarding that automobile or class of automobiles in a real time fashion.

### CROSS-REFERENCE TO RELATED APPLICATION

This application is based on and claims priority from co-pending U.S. Provisional Application Ser. No. 60/511,632, which was filed on Oct. 15, 2003, which is incorporated by reference herein.

### BACKGROUND OF THE INVENTION

The present invention relates to a method and system that provides information regarding a specific automobile (or class of automobiles) or other vehicle to a user device such as a handheld wireless device in order to aid a potential buyer in making a purchase decision.

The car sales industry has spawned a large amount of Internet development from point of sale tools to online auctions. Long time dealer services and resources are now provided electronically as well as through traditional methods. The focus of this opportunity is the services that are currently used and subscribed to by dealers as well as available resources that are as yet not utilized for the function of buying cars.

An automobile dealer must have the skills, knowledge and tools to buy a car at the appropriate price. In today's market there are a number of services that provide information and tools to help buyers purchase cars for resale more optimally. These services provide regionalized historical and calculated value information to aid a buyer in properly valuing a vehicle. These resources are rarely available to the buyer at the location or time of purchase by any means other than wholesale Black Book or NADA information in the form of a small printed publication or a download to a PDA.

At a base level the buying process can be described as follows. A buyer buys cars for resale at auction or from a potential customer with a trade-in or through a number of other resources. The buyer will examine the vehicle, look up it's relative wholesale values in a book or PDA he has on his person, draw on his own knowledge of the retail market value for that particular year, make and model, and make an assessment. About 5% of cars purchased are done so at unduly large prices, causing large dealerships tens of thousands of unit losses per month.

There are currently a number of online companies such as Trader Online (Auto Trader), Ebay and Carfax that represent a potential source of valuable information for dealerships when buying cars. These resources are currently used for evaluation or as sales tools only after the purchase has been made.

Improperly valued purchases can result in a loss of $1,000 to $3,000 per vehicle. It is estimated that an experienced dealer will realize this kind of loss on at least 5% of purchased vehicles every month. This can result in over $10,000 in losses for every 100 used cars purchased for resale.

Because of the fast pace of the business and the difficulty in retrieving evaluation information from existing common resources, dealers have relied on volume to discount individual losses. In addition, there are resources of information through online companies that have not yet been fully realized as a common tool for evaluation primarily due to the lack of availability of that information when it could be most effective.

Large dealers typically purchase 30-60 Carfax reports each month and subscribe to 20 or more copies of the Black Book wholesale information or similar publications like NADA as well as purchasing a few user licenses for the online service.

It is the intent of this invention to vastly increase the amount and type of information available to buyers and put it in the palm of their hand while inspecting the vehicle. In addition, we will allow the buyer to do this with little more than a single scan of the bar-coded VIN.

### SUMMARY OF THE INVENTION

The present invention is a system and methodology for providing timely information regarding an automobile or other vehicle from one or more sources linked by a global computer network such as the Internet to a device such as a hand-held portable wireless device, whereby the vehicle information may be displayed to a user and utilized by the user for making a purchase decision regarding that automobile or class of automobiles in a real time fashion.

A user of the present invention is provided with a portable device (or necessary software for a compatible device the user may own) such as a handheld computing device with wireless Internet capabilities and, optionally, automatic data input capabilities such as a bar code scanner. The user enters or scans the Vehicle Identification Number (VIN) of a vehicle under investigation, either by scanning a bar code located on the vehicle that is encoded with the VIN, or by manually entering the VIN on a touchscreen, keyboard or other data entry device on the handheld device. The VIN is processed and transmitted wirelessly, over an Internet or local area network connection, to a communications manager in a vehicular information system, which in turn passes the VIN to an information manager. The information manager checks an internal WAVIS (Wireless Automobile Valuation Information Service) database for internally stored information regarding the make, model and year of the vehicle (as determined by the VIN). The WAVIS system also communicates directly with one or more externally located information servers over the Internet. Information regarding the vehicle is collected by the WAVIS server and processed for downloading back to the handheld device. The user can then review the information provided, in real time, regarding the vehicle and then make an informed purchase decision on the vehicle.

In particular, the present invention is a method of and system for providing information regarding a motor vehicle in which vehicle index data (i.e. the VIN) is input into a device and then translated to a request for vehicular information. The request is transmitted to a remotely located vehicular information system, where information is retrieved that is relevant to the motor vehicle as a function of the request. The vehicular information system transmits the information relevant to the motor vehicle to the device, where it is displayed.

The device, which may be a portable, hand-held device, may have one or more of various input technologies for providing the vehicle index data, including but not limited to a bar code scanner, a radio frequency identification tag reader, a microwave tag reader, an optical reader, and/or manual input means such as a touchscreen.

Once the vehicle index data is input, information may be retrieved from a local repository of data (such as an on-board memory or cache) or it may be retrieved from a remote repository of data by either a selectively connected interface or a continuously connected interface.

The retrieved information relevant to the motor vehicle may be processed prior to transmitting the information to the device, and/or it may be processed after it is received from the vehicular information system. For example, a valuation process may be executed for the motor vehicle by utilizing the information obtained relevant to the motor vehicle, determining a range of value for said motor vehicle based on said valuation process, and then displaying said range of value on the device. Also, user parameter data may be entered via a user interface on the device; after which time the retrieved information may be processed in conjunction with the entered user parameter data. Further, the information relevant to the motor vehicle displayed on the device may be a function of the processed retrieved information in conjunction with the entered user parameter data. The user may be prompted by the device to enter the user parameter data during processing of the retrieved information relevant to the motor vehicle.

The scanned VIN may be used to obtain information regarding registration information, title information, inspection information, prior sales information, police information, insurance information, repair information, and/or recall information.

### BRIEF DESCRIPTION OF THE DRAWING

FIG. 1A is a bock diagram of the system of the present invention.

FIG. 1B is a detailed block diagram of the vehicular information system of the present invention.

FIG. 1C is a detailed block diagram of the user device of the present invention.

FIGS. 2A and 2B are a flowchart of the procedure of the present invention.

FIG. 3 is an example of a PDA with a display screen in accordance with the present invention.

### DETAILED DESCRIPTION OF THE PREFERRED EMBODIMENT

The present invention provides the following beneficial features. While inspecting the vehicle at auction or on the sales lot or literally anywhere, the buyer can scan the bar-coded VIN number of a vehicle and retrieve the following real-time information within seconds:
Year, Make, Model, Engine Size, Drive Line
Standard Features
Optional Features and their relative added value
Calculated wholesale values for the region
Recent wholesale historical data for that year-make-model vehicle
Retail, Private Party and Trade-In value of the vehicle
Vehicle history, title check, ownership records
The competition: The quantity and prices or price range of similar cars currently advertised in the dealerships area

For the Dealerships the system will:
Save dealers from monthly losses
Consolidate existing subscription information for the dealer
Increase the quantity, quality, usability and overall value of the information provided
Provide incomparable access to the information
Allow more staff to perform the duty of valuing vehicles by dramatically reducing the need for lengthy experience
Consolidate billing for existing subscriptions.

For Information Vendors the system will:
Generate new customers with higher usage rates
Provide cross over subscriptions between vendors
Increase usage from existing subscribers
Offer consolidated billing of thousands of accounts
Offer new channels of distribution for vendors whose information is not commonly used for this application.

The system contains checks and switches modifiable by the subscriber to tailor the evaluation criteria to their own specifications. For example, no longer would a user only rely on the buyers with vast experience to safely evaluate a vehicle (even they make a certain percentage of imprudent purchases each month). Parameters could be set to automatically set a price target for a car based on the information that would be provided by the service of this invention. The only evaluation would be a visual/hands on inspection of the vehicle. The market analysis would be set and a target buy price provided based on an expected margin. Alternately, a car could be rejected immediately or devalued based on a derogatory item from Carfax or saturation of the local market for that particular model.

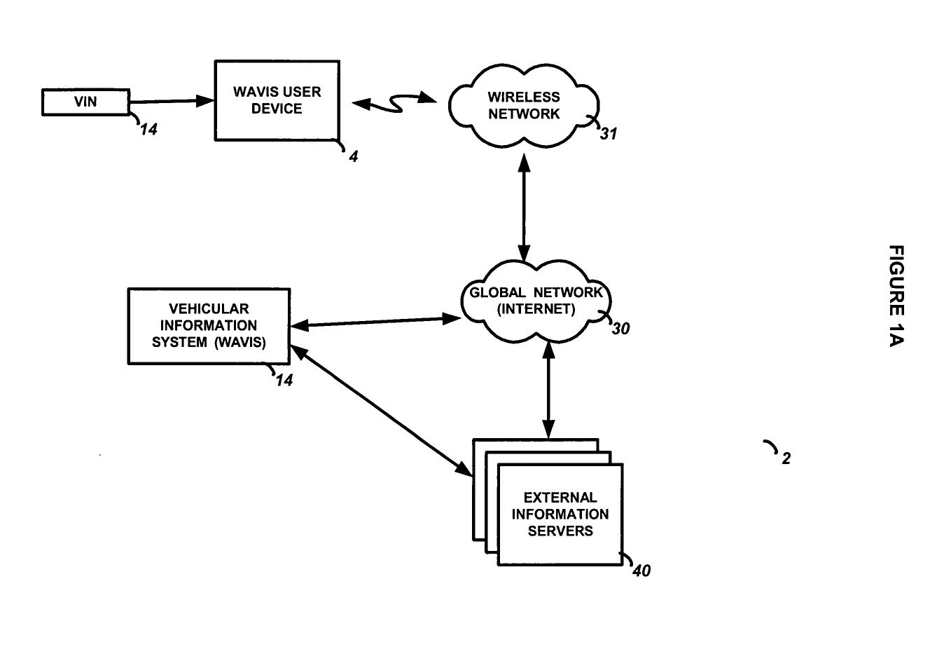

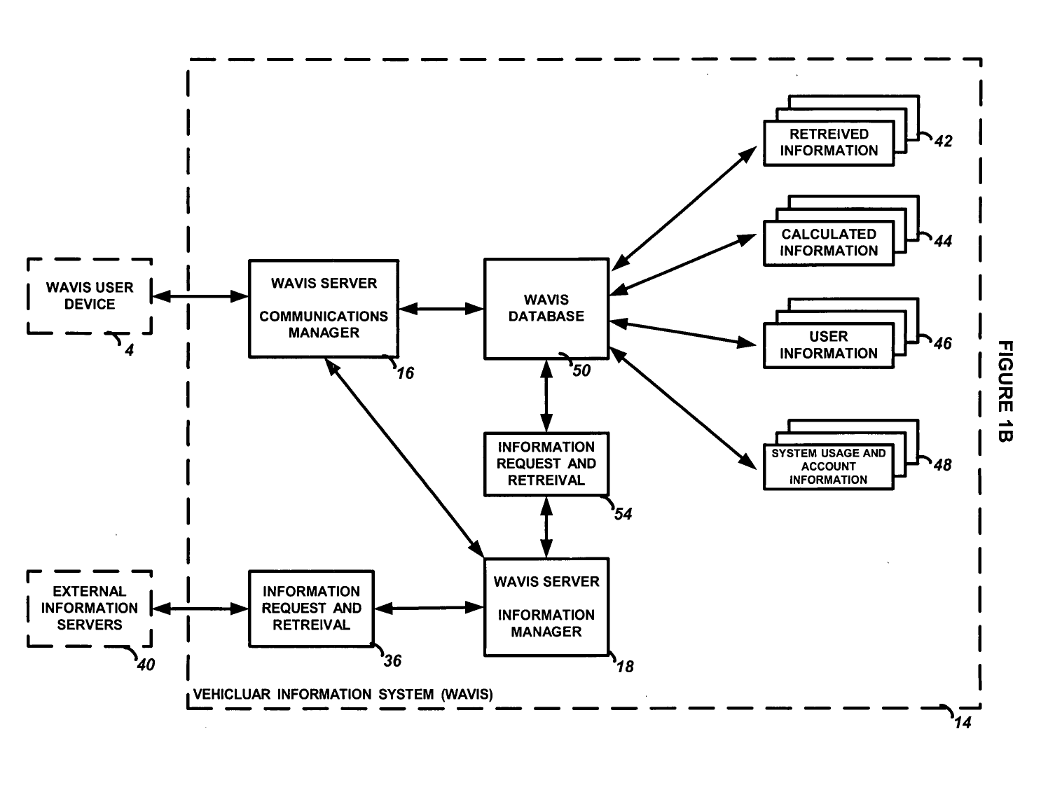

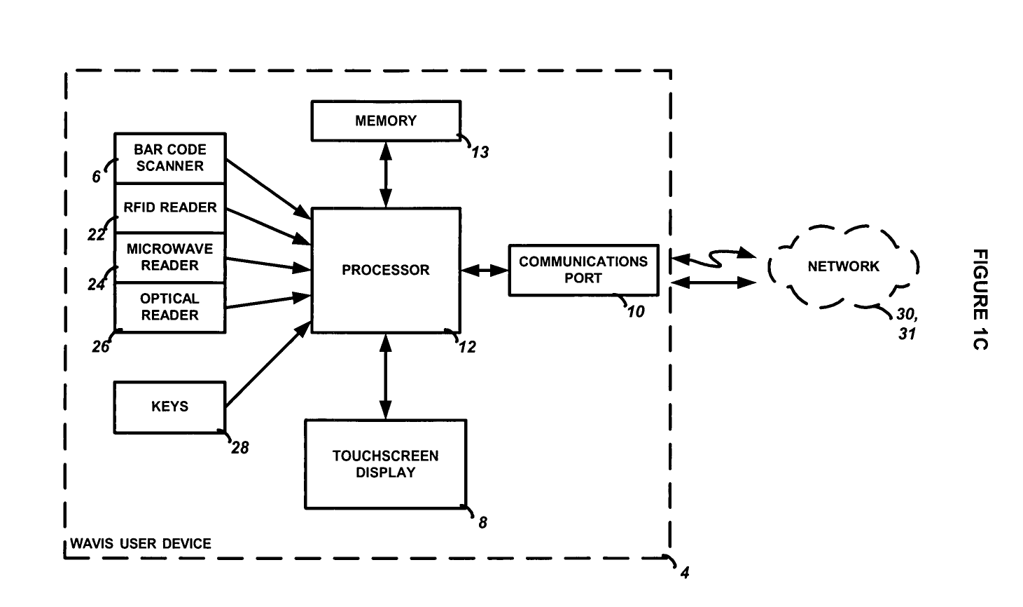

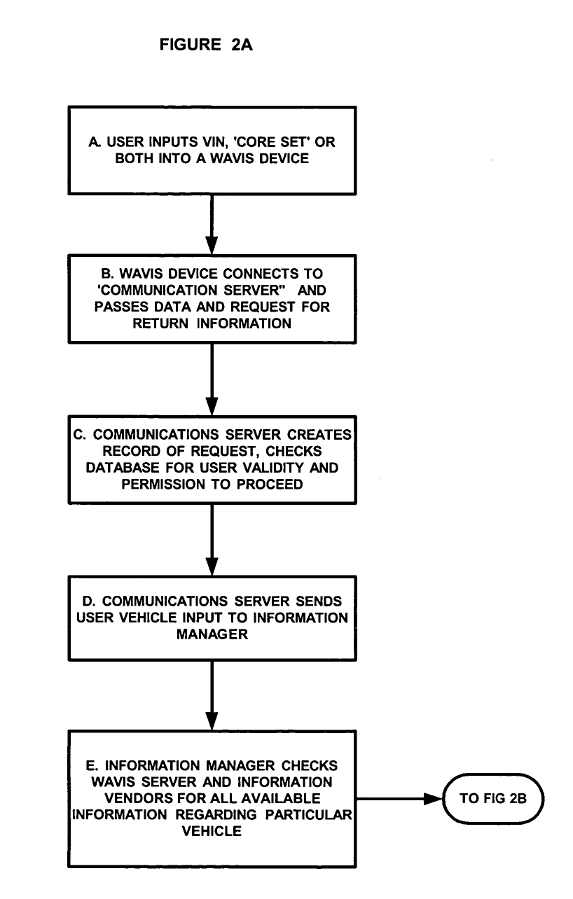

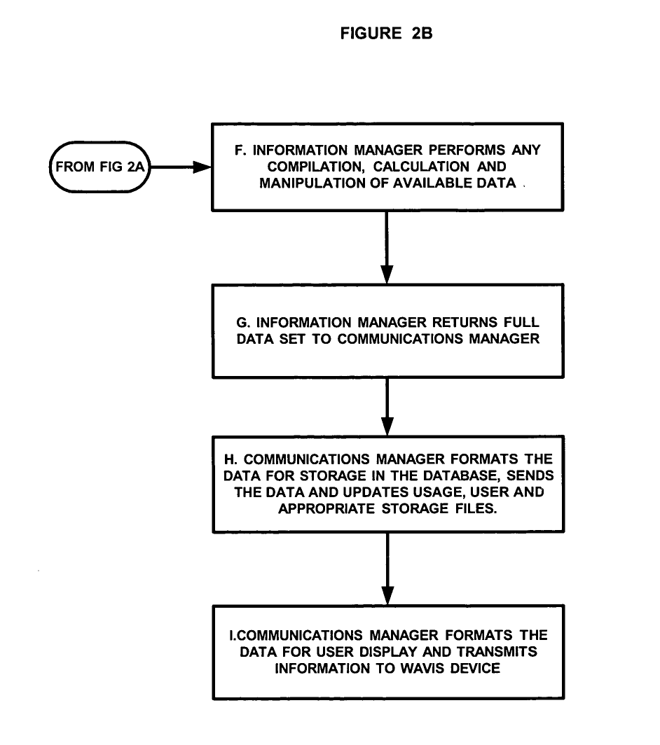

The present invention will now be described with reference to the attached Figures. FIG. 1A illustrates a system block diagram of the present invention 2. The flow of operations is set forth in the flowcharts of FIGS. 2A and 2B. A user of the system, who will typically be a person seeking to purchase a used automobile or other type of vehicle, will be provided with a WAVIS user device 4, which in the preferred embodiment is a portable handheld device such as a Portable Digital Assistant (PDA) by PALM, HANDSPRING, etc. The portable device 4 will be adapted for wireless communications with the Internet (or a Wi-Fi LAN) via a wireless network 31 and global network (Internet) 30 so that it can provide the vehicle's VIN to the remotely located vehicular information system 14 (also referred to as a WAVIS server) and receive information regarding the vehicle, all in real time without having to connect the device 4 to a desktop computer or the like. As such, a user in the field may implement the present invention as described herein.

The handheld device 4 is also adapted to scan bar codes or other types of machine-readable indicia. Since for most automobiles a vehicle's VIN 14 is encoded into a bar code symbol that is prominently displayed on the vehicle, the user can easily scan the VIN as a data input to the handheld device 4 at step A (the user may also input a core set of data as described below). The bar code symbol scanned by the user is decoded by a software program executing on the handheld device so as to provide the VIN, typically in ASCII format. The decoded VIN is then transmitted by the wireless network 31 and Internet connection 30 to the vehicular information system (the WAVIS server) 14 as well known in the art. In particular, the handheld device 4 is connected at step B to a communications manager application adapted to communicate with the handheld device.

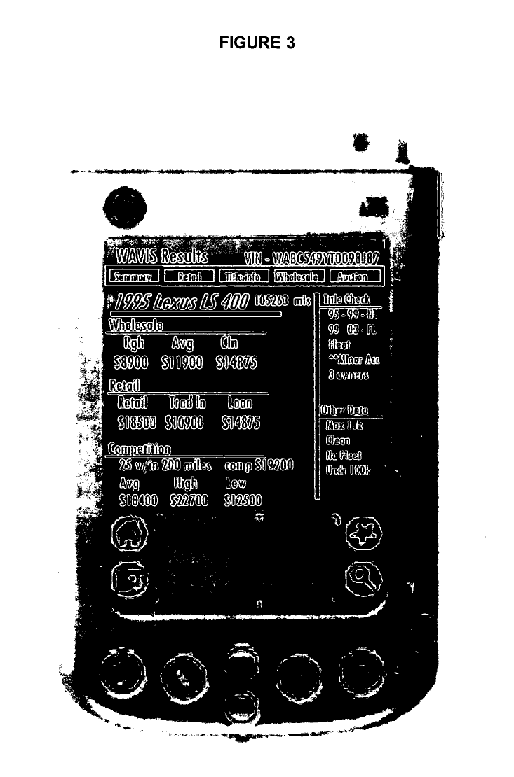

The handheld user device 4 is shown in detail in FIG. 1C. The user device 4 includes automatic data input functionality which may be a bar code scanner 6, an RFID (radio frequency identification tag) reader 22, a microwave reader 24, and/or an optical reader 26, all of which are well known in the art of automatic data input. In addition, the device 4 will have manual user data input functionality such as a touchcreen display 8 and/or keys 28, for manually entering information and controlling operation of the device 4. The device 4 will also have a processor 12, memory 13, and a communications port 10 (which may be wired or wireless) as well known in the art. For example, the device 4 may be a PDA modified to operate in accordance with this invention, such as by the addition of a wireless modem and a bar code scanner. FIG. 3 illustrates a PALM PILOT PDA device adapted in accordance with this invention.

The vehicular information system (WAVIS server) 14 is shown in detail in FIG. 1B. The WAVIS server 14 includes several main components, which are the communications manager 16, the WAVIS database 50, and the information manager 18. The WAVIS database stores various types of information, including retrieved information 42 (information retrieved from external information servers 40), calculated information 44, user information 46, and system usage and account information 48. The operation of the WAVIS server in conjunction with the entire system will be explained herein.

As previously mentioned, in addition (or in the alternative) to entering a VIN via a bar code scanner 6, a core set of data may be input into the handheld device, such as by touchscreen 8 input with a stylus or the like. The core set of data for a given vehicle includes the year, make, model and submodel of the vehicle. Although this core set of data will be helpful in looking up certain data about the vehicle, a full set of information will not be retrieved as with the VIN used as input. For example, the input of a VIN may provide information about that specific vehicle (e.g. if it has been involved in an accident) since the VIN is unique for each vehicle. (The decoded VIN will also indicate the year, make model, and submodel of the vehicle.) The core set of data cannot provide such detailed information since it refers to all such vehicles in that class (e.g. all 1999 Lincoln Navigators).

The VIN may be used to check all government, public and private records regarding the vehicle for which the VIN has been entered as one of the identifiers of the vehicle. This may include but is not limited to registration information, title submissions, inspection records, sale records, police reports, insurance claims, service and repair records, manufacturer recall and other information. This information is typically obtained by connecting to external information servers 40 via the Internet, although some of this data may be cached and stored locally if desired.

Once the VIN and/or core set of data is input to the handheld device, the data is stored locally on the handheld device and then transmitted to the communications manager 16 on the WAVIS server 14 via a wireless/wired Internet connection as well known in the art. The communications server 16 creates a record of the request and then refers to the user database 46 to ensure that the user is properly registered to the WAVIS system (step C). At step D, the communications server sends the user vehicle input to the information manager 18, and information for the VIN entered may then be retrieved by one or more of the following methodologies at step E. A query may be formulated by the information manager 18, directed at an external information server 40 that stores information regarding vehicles, such as CARFAX, KELLY BLUE BOOK, EDMUNDS, BLACK BOOK, MANHEIM, AUTOTRADER, EBAY, NADA, vehicle manufacturers, US Government agencies, and insurance agencies. The external information server 40 will receive the query and generate a response in a predetermined manner (step F); the response will be returned to the WAVIS server communications manager 16 for further processing (step G). The external information server will likely log the transaction, in particular if a fee is to be charged to the WAVIS server 14 on a per transaction basis (monthly or yearly fees may be charged in lieu of a transactional fee). In the alternative to a real-time query to an external information server 40, blocks of information may be periodically downloaded to the WAVIS server for storage in WAVIS database 50 and processing locally. For example, MANHEIM may have an arrangement whereby it sends information to the WAVIS server 14 each month for a predetermined fee. In this case, real-time queries need not be made by the WAVIS server.

At step H, the communication manager 16 formats the data for storage in the WAVIS database 50, and then sends the data back to the handheld device 4. The communications manager 16 also updates the usage database 48. At step I, the communications manager 16 formats the data for display on the device (a device-dependent step), and transmits the information to the WAVIS device 4.

In addition to the VIN and/or core set of data input by a user, other data may be input by the user into the device 4 to assist in formulating a more accurate analysis of the valuation of the vehicle. The system will perform calculations based on all available information about a specific vehicle or category of vehicles and/or user criteria to provide value parameters. Information that might also be entered by a user into the handheld device 4 includes expected margin thresholds, expected competing vehicle thresholds, vehicle location history thresholds, vehicle ownership threshold, derogatory title information threshold, and inventory threshold for a category of vehicles.

This user criteria is received by the WAVIS server 14 and utilized, along with information on the vehicle provided by the external information servers 40, to provide the user with vehicle valuation information. The vehicle information may be presented to the user in any desired format. In addition, the WAVIS system may be able to reject a vehicle for purchase (e.g. if certain user-define parameters are met or exceeded), raise or lower a maximum buy price, predict the number of days expected to sell the vehicle in the user's market, provide an estimated sales price and any statistical or policy driven analysis possible with the given information.

Three types of information are presented to the user by the WAVIS system. The first category is valuation information, which includes a combination of all available information for a particular vehicle or category of vehicles, any criteria provided by a user, any calculated values or information produced for the purpose of providing valuation for a vehicle or category of vehicles. The second category of information is user criteria and account information, which includes any of the information input by a user as well as the user account information. The third category of information provided to the user is report information, which is a record of system usage by the user, and may include all or some of the information stored in the WAVIS server for that particular user (or a group of users).

The WAVIS system will be comprised of the components shown in FIG. 1B as now further described herein.

The WAVIS database 50 will be comprised of a computer or group of computers/machines that may handle the storage of the following information: retrieved information 42, calculated information 44, user information 46, system usage information 48, handheld unit information, vendor information, and account information.

The device 4 may be any device that can be used to access the WAVIS system and either input and/or retrieve information provided by the WAVIS system. A device may be used for the following functionality: VIN input and recording, core set input and recording, WAVIS system communication, and information retrieval and information input. A device may communicate with the WAVIS system by a wireless connection to a data provider or a wireless LAN connection with a PC or network server that handles communication with the WAVIS system.

The following information may be provided by the WAVIS system. (This information can be tailored to National, Regional, City, County or individual Zip Code restrictions.)

Wholesale Information—estimated average, rough & clean wholesale values for a given week or month for similar or identical vehicles

Historical Auction Information—recent selling price for similar or identical vehicles sold at auction; average miles for similar or identical vehicles sold at auction; average selling price for similar or identical vehicles sold at auction.

Title/VIN related information—title history, registration records, accident reports, insurance claims, location history, ownership history, any title or registration related information.

Competitive Data (within a chosen range of a given zip code)—number of similar or identical cars currently or recently for sale; average, high & low asking price for similar or identical cars currently or recently for sale; average miles for similar or identical cars currently or recently for sale; focused immediate competition based on miles on vehicle and/or other features for similar or identical cars currently or recently for sale.

Market Data—estimated retail value, estimated trade in value, estimated loan value.

Condition—the standard terminology for vehicle condition according to the Black Book is used (rough, average, clean). In addition, the condition “extra clean” is implemented herein.

A vendor system is any system by which the WAVIS system may communicate to retrieve information regarding a particular vehicle or category of vehicles based on a VIN or ‘Core Set’ or the combination of the two.

A device may be anything that is capable of user input, communication with the WAVIS system, and display of at least some of the information provided by WAVIS. They may include but are not limited to a desktop PC, laptop PC, personal data assistants (PDAs), pocket PCs, tablet PCs, portable computers/scanning computers, pagers, phones, and web enabled phones.

The wireless network will be any service, such as a cellular network or a local area network (LAN) (such as a Wi-Fi system) that will facilitate the functionality of the WAVIS system.

1. A method of providing information regarding a motor vehicle comprising the steps of:
inputting vehicle index data into a device;
translating said input index data to a request for vehicular information;
transmitting said request to a remotely located vehicular information system;
the vehicular information system retrieving information relevant to the motor vehicle as a function of the request;
the vehicular information system transmitting said information relevant to the motor vehicle to the device;
the device displaying said information relevant to the motor vehicle.

2. The method of claim 1 wherein the device is a portable, hand-held device.

3. The method of claim 1 wherein the step of inputting vehicle index data into a device comprises the step of scanning a bar code symbol encoded with an identifier unique to the motor vehicle.

4. The method of claim 1 wherein the step of inputting vehicle index data into a device comprises the step of reading a radio frequency identification tag encoded with an identifier unique to the motor vehicle.

5. The method of claim 1 wherein the step of inputting vehicle index data into a device comprises the step of reading via microwave transmission a tag encoded with an identifier unique to the motor vehicle.

6. The method of claim 1 wherein the step of inputting vehicle index data into a device comprises the step of optically reading a symbol encoded with an identifier unique to the motor vehicle.

7. The method of claim 1 wherein the step of inputting vehicle index data into a device comprises the step of encoded with an identifier unique to the motor vehicle.

8. The method of claim 3 wherein the identifier unique to the motor vehicle is a VIN (vehicle identification number).

9. The method of claim 1 wherein the step of inputting vehicle index data into a device comprises the step of entering a core set of data regarding the vehicle, said core set of data comprising one or more of a year, make, model, submodel, mileage, rated condition, OEM features, and standard features of the vehicle.

10. The method of claim 1 wherein the step of the vehicular information system retrieving information relevant to the motor vehicle as a function of the request comprises the step of retrieving information from a local repository of data.

11. The method of claim 1 wherein the step of the vehicular information system retrieving information relevant to the motor vehicle as a function of the request comprises the step of retrieving information from a remote repository of data by selectively interconnecting with said remote repository of data;
obtaining said information; and
selectively disconnecting from said remote repository of data.

12. The method of claim 1 wherein the step of the vehicular information system retrieving information relevant to the motor vehicle as a function of the request comprises the step of retrieving information from a remote repository of data, wherein the vehicular information system is continuously interconnected to the remote repository of data.

13. The method of claim 11 wherein said remote repository of data comprises information on a class of car identified by the vehicle index data.

14. The method of claim 11 wherein said remote repository of data comprises information on the specific car uniquely identified by the vehicle index data.

15. The method of claim 1 further comprising the step of processing the retrieved information relevant to the motor vehicle prior to transmitting said information to the device.

16. The method of claim 1 further comprising the step of processing the retrieved information relevant to the motor vehicle at the device after said information is received from the vehicular information system.

17. The method of claim 16 further comprising the steps of:
entering user parameter data via a user interface on the device; and
processing the retrieved information relevant to the motor vehicle at the device in conjunction with the entered user parameter data.

18. The method of claim 17 wherein the information relevant to the motor vehicle displayed on the device is a function of the processed retrieved information in conjunction with the entered user parameter data.

19. The method of claim 24 wherein the user parameter data is entered prior to receiving the retrieved information relevant to the motor vehicle.

20. The method of claim 24 wherein the user parameter data is entered after receiving the retrieved information relevant to the motor vehicle.

21. The method of claim 20 in which the user is prompted by the device to enter the user parameter data during processing of the retrieved information relevant to the motor vehicle.

22. The method of claim 8 wherein the scanned VIN is used to obtain information regarding registration information, title information, inspection information, prior sales information, police information, insurance information, repair information, and/or recall information.

23. The method of claim 1 further comprising the steps of
performing a valuation process on the motor vehicle, utilizing the information obtained relevant to the motor vehicle;
determining a range of value for said motor vehicle based on said valuation process; and
displaying said range of value on the device.

24. A system for providing information regarding a motor vehicle comprising:
a device comprising:
means for inputting vehicle index data;
display means;
a wireless communications interface for communicating wirelessly over a computer network; and
processing means adapted to
receive vehicle index data input into the device;
translate the input index data to a request for vehicular information; and
transmit said request to a remotely located vehicular information system via the wireless communications interface; and
a remotely located vehicular information system comprising:
means for receiving the request for vehicular information;
means for retrieving information relevant to the motor vehicle as a function of the received request; and
means for transmitting said information relevant to the motor vehicle to the device.

25. The system of claim 24 wherein the device is a portable, hand-held device.

26. The system of claim 24 wherein the means for inputting vehicle index data comprises a bar code scanner.

27. The system of claim 24 wherein the means for inputting vehicle index data comprises a radio frequency identification tag reader.

28. The system of claim 24 wherein the means for inputting vehicle index data comprises a microwave identification tag reader.

29. The system of claim 24 wherein the means for inputting vehicle index data comprises an optical scanner.

30. The system of claim 24 wherein the means for inputting vehicle index data comprises manual data entry means.

31. The system of claim 30 wherein the manual data entry means comprises a touchscreen device integrated with the display means.

32. The system of claim 24 wherein the wireless communications interface comprises a cellular telecommunications interface, and wherein the device communicates with the remotely located vehicular information system via a cellular telecommunications network.

33. The system of claim 24 wherein the wireless communications interface comprises a wireless LAN telecommunications interface, and wherein the device communicates with the remotely located vehicular information system via a wireless LAN telecommunications network.

34. The system of claim 24 wherein the means for receiving the request for vehicular information and the means for transmitting said information relevant to the motor vehicle to the device comprises a communications manager server, and wherein the means for retrieving information relevant to the motor vehicle as a function of the received request comprises an information manager and a local repository of data, the local repository of data comprising stored information obtained from at least one external information service.

35. The system of claim 34 further comprising means for communicating via a computer network with a remote repository of data, and wherein said means for retrieving information relevant to the motor vehicle as a function of the received request is adapted to communicate with a remote repository of data to obtain further information relevant to the motor vehicle at substantially the same time that the request is received by the remotely located vehicular information system.

36. The system of claim 24 wherein the processing means is further adapted to process the retrieved information relevant to the motor vehicle after said information is received from the remotely located vehicular information system.

37. The system of claim 36 wherein the device further comprises a user interface, and wherein the processing means is further adapted to process the retrieved information relevant to the motor vehicle in conjunction with user parameter data entered via the user interface.

38. The system of claim 37 wherein the processing means is further adapted to prompt a user to enter the user parameter data during processing of the retrieved information relevant to the motor vehicle.
